(19) United States
(12) Patent Application Publication
(10) Pub. No.: US 2026/0079383 A1
(43) Pub. Date: Mar. 19, 2026

(54) DRIVING MECHANISM

(71) Applicant: TDK TAIWAN CORP., Taoyuan City (TW)

(72) Inventors: Jui-Ta CHIEN, Taoyuan CIty (TW); Po-Xiang ZHUANG, Taoyuan CIty (TW); Kun-Shih LIN, Taoyuan CIty (TW)

(21) Appl. No.: 19/325,861

(22) Filed: Sep. 11, 2025

Related U.S. Application Data
(60) Provisional application No. 63/694,389, filed on Sep. 13, 2024.

(51) Int. Cl. G03B 13/36; G02B 7/09; G02B 13/00; G03B 30/00; H02K 41/035

(52) U.S. Cl. CPC G03B 13/36; G02B 7/09; G02B 13/001; H02K 41/0354; G03B 30/00

(57) ABSTRACT

A driving mechanism for moving an optical element is provided. The driving mechanism includes a fixed part, a movable part, and a driving assembly. The movable part is movably connected to the fixed part for holding the optical element. The driving assembly is configured to move the optical element relative to the fixed part.

### CROSS REFERENCE TO RELATED APPLICATIONS

This application claims the benefit of U.S. provisional application No. 63/694,389, filed Sep. 13, 2024, the entirety of which is incorporated by reference herein.

### BACKGROUND OF THE INVENTION

### Field of the Invention

The present invention relates to a driving mechanism, and, in particular, it relates to a driving mechanism for moving an optical element.

### Description of the Related Art

As technology has advanced, a lot of electronic devices (for example, laptop computers and smartphones) have incorporated the functionality of taking photographs and recording video. These electronic devices have become more commonplace, and have been developed to be more convenient and thin. More and more options are provided for users to choose from.

Electronic devices usually use several coils and magnets to adjust the focus of a lens. However, miniaturization of these electronic devices may increase the difficulty of mechanical design, and this may also lead to low reliability and a lower positioning accuracy of the driving mechanism. It has been a challenge to address this problem.

### BRIEF SUMMARY OF THE INVENTION

An embodiment of the present invention provides a driving mechanism for moving an optical element. The driving mechanism includes a fixed part, a movable part, and a driving assembly. The movable part is movably connected to the fixed part for holding the optical element. The driving assembly is configured to move the optical element relative to the fixed part.

In some embodiments, the driving mechanism further includes a stopper, a buffer element, and an elongated positioning element. The movable part includes a holder and a frame connected to each other. The stopper is disposed on the frame. The positioning element and the optical element are disposed on the holder. The buffer element is connected to the stopper and the positioning element to absorb the vibration generated by the driving mechanism.

### BRIEF DESCRIPTION OF THE DRAWINGS

The present invention can be more fully understood by reading the subsequent detailed description and examples with references made to the accompanying drawings, wherein:

FIG. 1 shows an exploded view of a driving mechanism 100 according to an embodiment of the present invention.

FIG. 2 shows another exploded view of the driving mechanism 100 in FIG. 1.

FIG. 3 shows a perspective diagram of the driving mechanism 100 in FIGS. 1 and 2 after assembly.

FIG. 4 is a partially enlarged view of the driving mechanism 100 shown in FIG. 3 with the housing H and the stopper K removed.

FIG. 5 shows a schematic diagram of a buffer element G that is disposed in the recess LH1 and connected to the positioning elements N, the stopper K, and the magnetic element M2.

FIG. 6 shows an enlarged partial cross-sectional view of the base B, the magnetic element M1, the magnetic permeable plate Q, the frame F, and the coil C1 after assembly.

FIG. 7 shows a perspective diagram of the base B and the guide rod R in FIG. 1.

FIG. 8 shows an enlarged perspective diagram of a plurality of magnetic elements M1 disposed on the base B.

FIG. 9 shows a schematic diagram of the magnetic permeable plate Q covering the outer surface of the magnetic element M1 in FIG. 8.

FIG. 10 is a schematic diagram showing that the central axis BZ of the base B deviates from the optical axis O of the optical element L.

### DETAILED DESCRIPTION OF THE INVENTION

The making and using of the embodiments of the driving mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

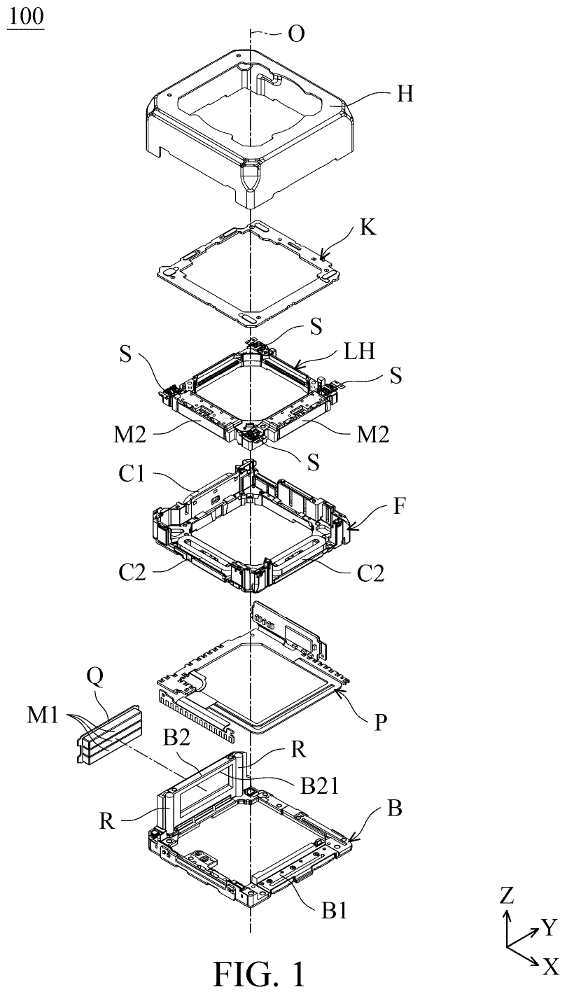

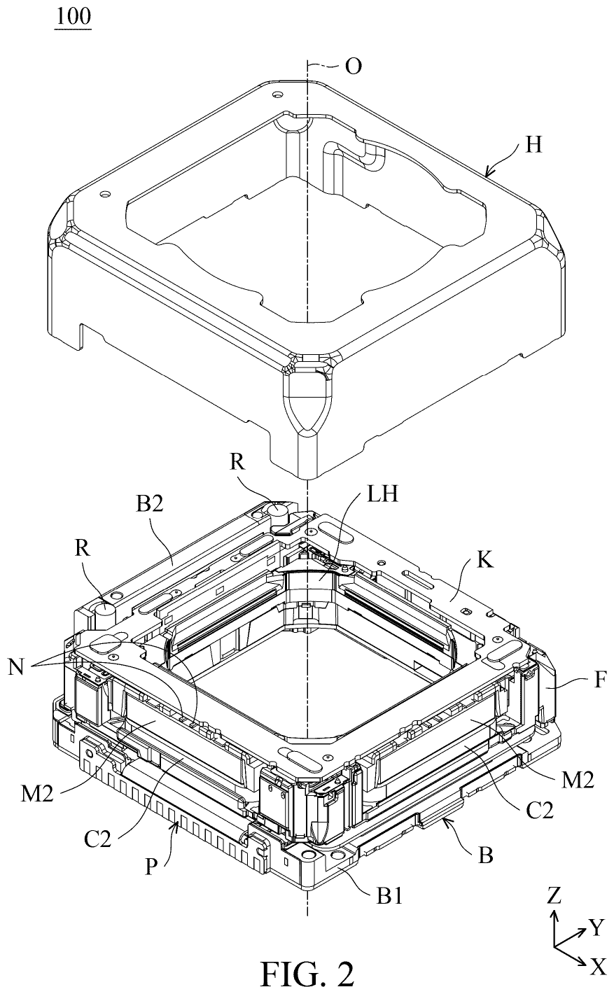

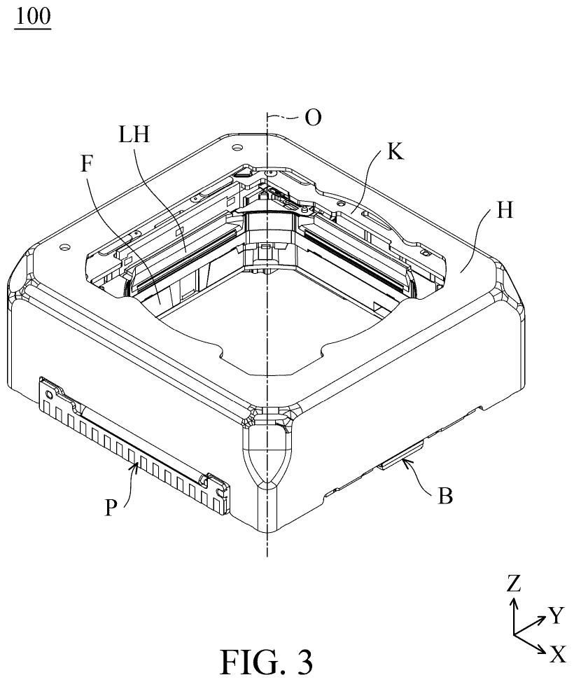

FIG. 1 shows an exploded view of a driving mechanism 100 according to an embodiment of the present invention. FIG. 2 shows another exploded view of the driving mechanism 100 in FIG. 1. FIG. 3 shows a perspective diagram of the driving mechanism 100 in FIGS. 1 and 2 after assembly.

As shown in FIGS. 1, 2, and 3, the driving mechanism 100 in this embodiment is a voice coil motor (VCM), which can be installed in a mobile phone or other portable electronic device to drive an optical element (e.g. an optical lens) to move, thereby achieving the functions of auto focusing (AF) and optical image stabilization (OIS).

The driving mechanism 100 includes a hollow housing H, a base B, a circuit assembly P, a holder LH, a frame F, a stopper K, a plurality of sheet springs S, a plurality of guide rods R, a plurality of magnetic elements M1, M2 (e.g. magnets), and a plurality of coils C1, C2. The stopper K may comprise metal, and the base B, the holder LH, and the frame F may comprise plastic or fiberglass.

In this embodiment, the housing H has a hollow structure and is joined with the base B. The circuit assembly P is disposed between the frame F and the base B, thereby electrically connecting the coils C1 and C2 to an external circuit.

It should be noted that the housing H and base B constitute a fixed part of the driving mechanism 100. The base B has a rectangular structure B1 and a wall portion B2 protruding from the rectangular structure B1 in the Z direction. The magnetic elements M1 are affixed in an opening B21 of the wall portion B2, and a magnetic permeable plate Q is disposed on the outer side of the magnetic elements M1 to enhance the electromagnetic driving force of the driving mechanism 100.

The holder LH is movably disposed in the housing H, and an optical element (not shown) may be disposed in the holder LH. The holder LH and the frame F constitute a movable part that can move relative to the fixed part (the housing H and the base B), and the optical element has an optical axis O parallel to the Z axis.

Here, the holder LH is connected to the frame F via the sheet springs S, thus allowing the holder LH to move relative to the frame F along the X axis and/or the Y axis. The guide rod R is sandwiched between the frame F and the wall portion B2 of the base B, thus allowing the frame F to move relative to the base B along the Z axis. Furthermore, the stopper K is affixed to the top side of the frame F, thus preventing the holder LH from falling off the frame F.

It should be noted that coils C1 and C2 are both mounted on the frame F, and the magnetic elements M2 are mounted on the holder LH. The position of coil C1 corresponds to the magnetic element M1 on the base B, and the position of coil C2 corresponds to the magnetic element M2 on the frame F. Here, the coils C1, C2 and magnetic elements M1, M2 constitute a driving assembly that can drive the frame F and holder LH to move relative to the fixed portion (the housing H and the base B), thereby achieving the functions of auto focusing (AF) and optical image stabilization (OIS).

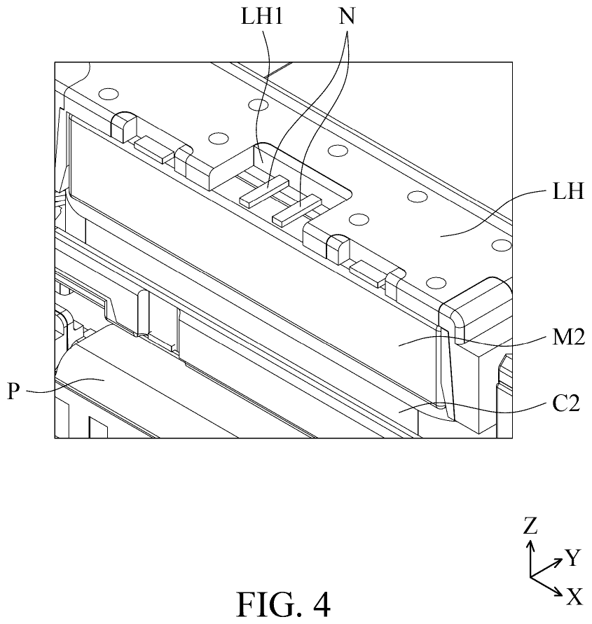

FIG. 4 is a partially enlarged view of the driving mechanism 100 shown in FIG. 3 with the housing H and the stopper K removed.

As shown in FIG. 4, a recess LH1 is formed on the outer side of the holder LH, and at least one elongated positioning element N is disposed in the recess LH1. In this embodiment, two positioning elements N are provided in the recess LH1 and extend in the −Y direction (first direction).

The positioning elements N may be thin metal pins that are embedded in the holder LH by insert molding. The magnetic element M2 is located between the positioning element N and the coil C2 along the Z axis. The positioning elements N may comprise magnetic permeable material, but the material and shape of the positioning element N are not limited to those disclosed in the embodiments of the present invention.

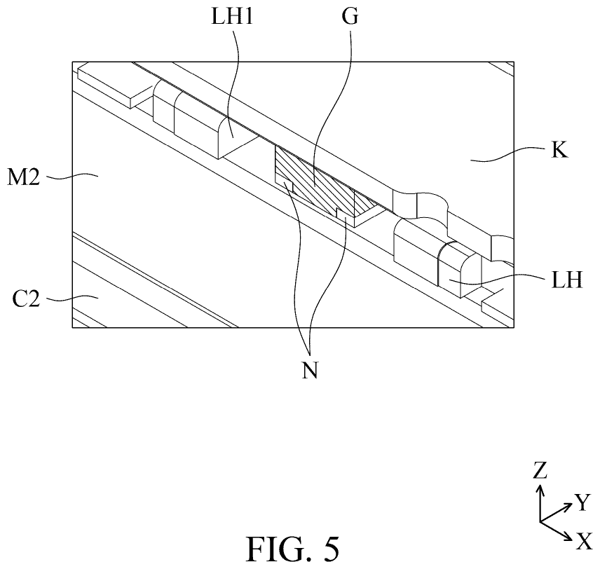

FIG. 5 shows a schematic diagram of a buffer element G that is disposed in the recess LH1 and connected to the positioning elements N, the stopper K, and the magnetic element M2.

As shown in FIG. 5, during assembly of the driving mechanism 100, a buffer element G (e.g. damping gel) may be disposed in the recess LH1 of the holder LH and in contact with the positioning element N, the stopper K, and the magnetic element M2.

With the buffer element G disposed between the stopper K and the magnetic element M2, the impact force of the holder LH when it contacts the stopper K during movement relative to the frame F along the Z axis can be reduced. Moreover, the buffer element G can also be used to absorb the vibration generated by the driving mechanism 100 during operation.

Additionally, since a part of the buffer element G is located between the two parallel positioning elements N, the buffer element G can be effectively prevented from falling off the recess LH1 of the holder LH, whereby the stability and reliability of the driving mechanism 100 can be improved.

In some embodiments, the buffer element G may not contact the magnetic element M2, and it may be connected between the stopper K and the frame F to absorb the vibration generated by the driving mechanism 100 during operation. Therefore, the present invention is not limited to the embodiments disclosed herein.

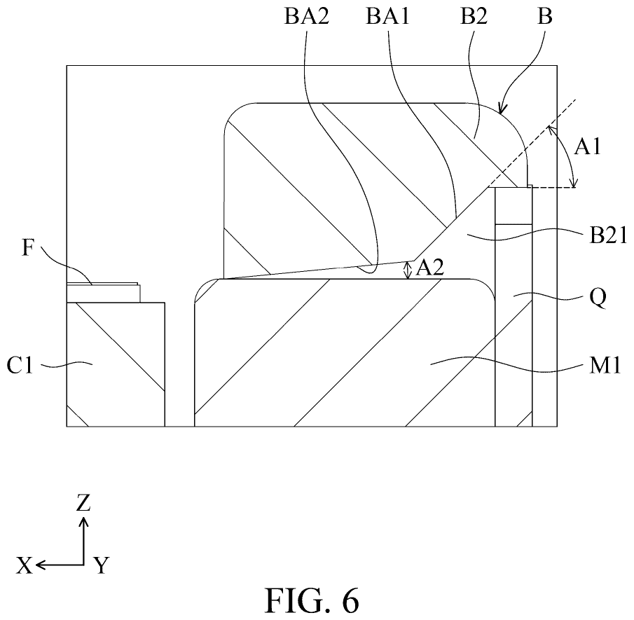

FIG. 6 shows an enlarged partial cross-sectional view of the base B, the magnetic element M1, the magnetic permeable plate Q, the frame F, and the coil C1 after assembly.

During assembly of the driving mechanism 100, as shown in FIG. 6, the magnetic element M1 and the magnetic permeable plate Q are installed into the opening B21 from the outer side of the wall portion B2 of the base B in the X direction. Here, the magnetic element M1 is located adjacent to the coil C1 on the frame F.

It should be noted that the opening B21 has a tapered structure extending in the X direction (second direction). The tapered structure has a first side surface BA1 and a second side surface BA2 that are connected to each other. The first side surface BA1 has a first sloped angle A1 relative to the X direction, and the second side surface BA2 has a second sloped angle A2 relative to the X direction. In this embodiment, the first sloped angle A1 is greater than the second sloped angle A2, thereby improving the positioning accuracy and enabling easy and convenient assembly of the magnetic elements M1.

In this embodiment, the first sloped angle A1 is within a range of 15 to 75 degrees, and the second sloped angle A2 is less than 3 degrees. However, the ranges of the first sloped angle A1 and the second sloped angle A2 can be adjusted according to design requirements and are not limited to those disclosed in the embodiments of the present invention.

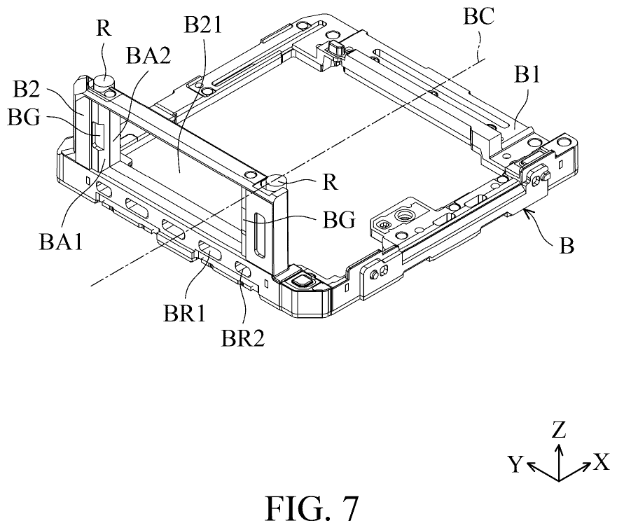

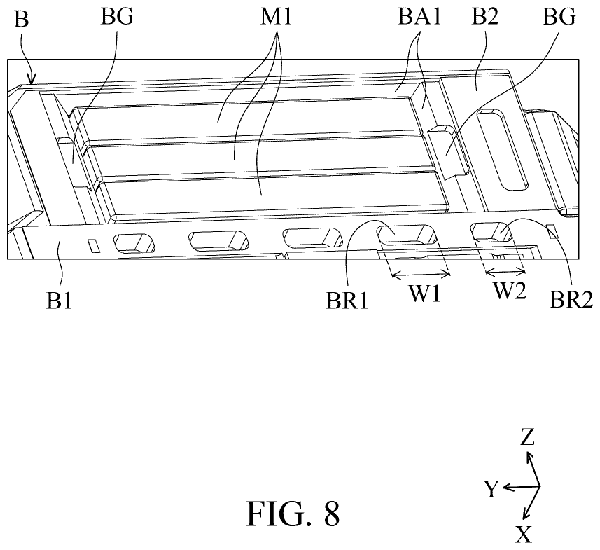

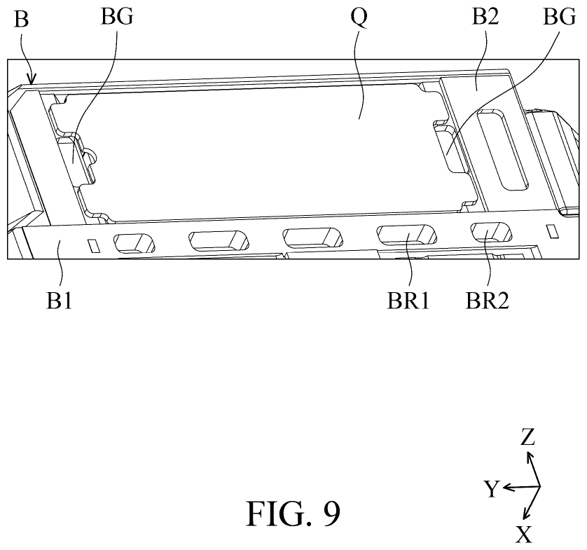

FIG. 7 shows a perspective diagram of the base B and the guide rod R in FIG. 1. FIG. 8 shows an enlarged perspective diagram of a plurality of magnetic elements M1 disposed on the base B. FIG. 9 shows a schematic diagram of the magnetic permeable plate Q covering the outer surface of the magnetic element M1 in FIG. 8.

As shown in FIGS. 7, 8 and 9, two recessed structures BG are formed on the wall portion B2 of the base B and located adjacent to the first side surface BA1 of the rectangular opening B21. During assembly, glue can be applied to the recessed structure BG, whereby the magnetic elements M1 and the magnetic permeable plate Q can be adhered to the wall portion B2 of the base B.

Referring to FIG. 9, the magnetic permeable plate Q does not cover the recessed structures BG, and the magnetic permeable plate Q and the recessed structures BG do not overlap when viewed along the X direction. Additionally, when viewed along the direction perpendicular to the X axis, the magnetic permeable plate Q and the recessed structure BG do not overlap, and the recessed structures BG are located adjacent to the edge of the magnetic permeable plate Q.

Still referring to in FIGS. 7, 8 and 9, a longitudinal first cavity BR1 and a longitudinal second cavity BR2 are formed on the lateral surface of the rectangular structure B1 of the base B. The first and second cavities BR1 and BR2 are located below the opening B21 and arranged along the Y direction. Moreover, the long axes of the first cavity BR1 and the second cavity BR2 are both parallel to the Y axis.

Specifically, as shown in FIG. 8, the first width W1 of the first cavity BR1 in the Y direction is greater than the second width W2 of the second cavity BR2 in the Y direction. The first cavity BR1 is closer to the central line BC of the base B (FIG. 7) than the second cavity BR2, and the central line BC is parallel to the X direction (second direction).

With the first and second cavities BR1 and BR2 are formed on the base B, the variation of dimension shrinkage of the base B due to uneven cooling and solidification after injection molding can be avoided. Thus, the dimensional accuracy of the base B after molding can be improved. In addition, the weight of the base B can also be effectively reduced, which in turn helps reduce the weight of the driving mechanism 100.

It should be noted that one or more magnetic elements M1 may be stacked along the Z axis and received in the opening B21 of the wall portion B2 of the base B. However, the number and arrangement of the magnetic elements M1 are not limited to those disclosed in the embodiment of the present invention.

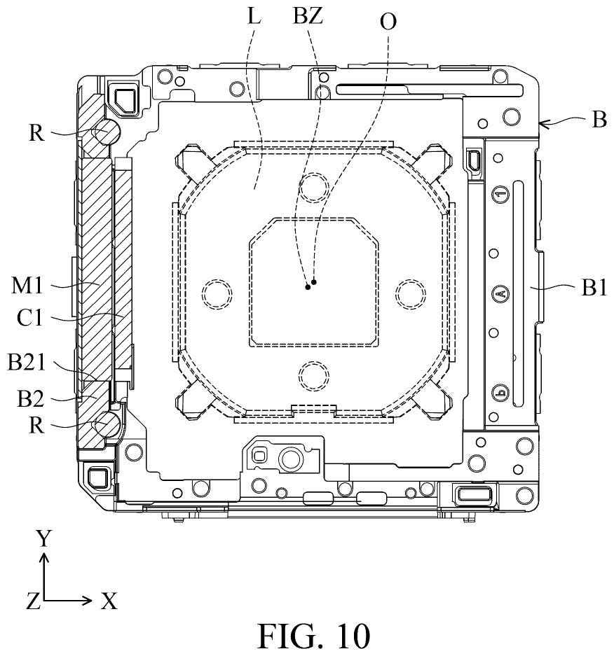

FIG. 10 is a schematic diagram showing that the central axis BZ of the base B deviates from the optical axis O of the optical element L.

As shown in FIG. 10, the base B has a central axis BZ perpendicular to the XY plane and offset from the optical axis O of the optical element L that is mounted on the holder LH. When viewed along the central axis BZ or the optical axis O, the rectangular structure B1 of the base B surrounds the optical element L.

Still referring to FIG. 10, the guide rods R are positioned on the inner side of the wall portion B2 of the base B. The magnetic elements M1 are received in the opening B21 of the wall portion B2 and located adjacent to the coil C1 on the frame F. Moreover, the central axis BZ is closer to the guide rod R, the magnetic element M1, the coil C1 and the wall portion B2 of the base B than the optical axis O of the optical element L.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification.

As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A driving mechanism for driving an optical element to move, wherein the optical element has an optical axis, and the driving mechanism comprises:
a fixed part;
a movable part, movably connected to the fixed part for holding the optical element; and
a driving assembly, configured to drive the movable part to move relative to the fixed part.

2. The driving mechanism as claimed in claim 1, further comprising a stopper, a buffer element, and an elongated positioning element, wherein the movable part includes a holder and a frame connected to each other, the stopper is disposed on the frame, and the positioning element and the optical element are disposed on the holder, wherein the buffer element is connected to the stopper and the positioning element to absorb the vibration generated by the driving mechanism.

3. The driving mechanism as claimed in claim 2, wherein the driving assembly includes a magnetic element and a coil, the magnetic element is disposed on the frame, the coil is disposed on the frame, and the buffer element is connected to the magnetic element.

4. The driving mechanism as claimed in claim 3, wherein the magnetic element is located between the positioning element and the coil along the optical axis.

5. The driving mechanism as claimed in claim 2, further comprising two positioning elements embedded in the holder by insert molding, wherein the buffer element is connected to the positioning elements.

6. The driving mechanism as claimed in claim 5, wherein the positioning elements comprise two thin metal pins extending in a first direction that is perpendicular to the optical axis.

7. The driving mechanism as claimed in claim 2, wherein the holder forms a recess for receiving the positioning element and the buffer element.

8. The driving mechanism as claimed in claim 2, wherein the buffer element comprises damping gel.

9. The driving mechanism as claimed in claim 2, wherein the positioning element comprises magnetic permeable material.

10. The driving mechanism as claimed in claim 2, wherein the stopper comprises metal, and the holder comprises plastic or fiberglass.

11. The driving mechanism as claimed in claim 1, wherein the fixed part has a housing and a base affixed to each other, and the base forms a first cavity and a second cavity, wherein the first cavity has a first width along a first direction, the second cavity has a second width along the first direction, the first width is greater than the second width, and the first direction is perpendicular to the optical axis.

12. The driving mechanism as claimed in claim 11, wherein the first cavity is closer to a central line of the base than the second cavity, and the central line is perpendicular to the first direction and the optical axis.

13. The driving mechanism as claimed in claim 11, wherein the first and second cavities are arranged in the first direction.

14. The driving mechanism as claimed in claim 11, wherein the first and second cavities have a longitudinal structure, and the long axes of the first and second cavities are parallel to the first direction.

15. The driving mechanism as claimed in claim 1, wherein the driving assembly includes a magnetic element and a coil, and the fixed part has a housing and a base affixed to each other, wherein the base has a rectangular structure and a wall portion protruding from the rectangular structure along the optical axis, the magnetic element is received in an opening of the wall portion, and the coil is disposed on the movable part.

16. The driving mechanism as claimed in claim 15, wherein the opening has a tapered structure extending toward an inner side of the wall portion, and the tapered structure forms a first side surface and a second side surface that are connected to each other, wherein the first side surface has a first sloped angle relative a second direction, the second side surface has a second sloped angle relative to the second direction, and the first sloped angle is greater than the second sloped angle.

17. The driving mechanism as claimed in claim 16, wherein the first sloped angle is within a range of 15 to 75 degrees, and the second sloped angle is less than 3 degrees.

18. The driving mechanism as claimed in claim 16, further comprising a glue, wherein the wall portion has a recessed structure adjacent to the first side surface, and the glue is disposed in the recessed structure.

19. The driving mechanism as claimed in claim 16, wherein the driving assembly includes a plurality of magnetic elements and a magnetic permeable plate, the magnetic elements are arranged along the optical axis and received in the opening of the wall portion, and the magnetic permeable plate is disposed on an outer side of the magnetic elements.

20. The driving mechanism as claimed in claim 1, wherein the fixed part has a housing and a base affixed to each other, and the base has a central axis that is parallel to and offset from the optical axis.
